(19) United States
(12) Patent Application Publication
(10) Pub. No.: US 2010/0092769 A1
(43) Pub. Date: Apr. 15, 2010

(54) SCINTILLATOR PANEL AND METHOD FOR MANUFACTURING THE SAME

(75) Inventors: Takehiko Shoji, Tokyo (JP); Yasushi Nakano, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 12/531,077

(22) PCT Filed: Feb. 22, 2008
(86) PCT No.: PCT/JP2008/053054

§ 371 Date: Sep. 14, 2009

(30) Foreign Application Priority Data
Mar. 23, 2007 (JP) 2007076448

(51) Int. Cl. B32B 5/00; B32B 27/06; B29C 43/24

(52) U.S. Cl. 428/337; 428/473.5; 428/480; 264/241

(57) ABSTRACT

Provided is a scintillator panel having excellent sharpness and graininess. In the scintillator panel, the scintillator panel and a surface of a planar light receiving element can be brought into uniform contact with each other within the surface, and deterioration of sharpness between the scintillator panel surface and the surface of the planar light receiving element is reduced. Furthermore, a method for manufacturing such scintillator panel is also provided. The scintillator panel is provided by arranging a phosphor layer composed of phosphor columnar crystal on a polymer film substrate. A leading end portion of the phosphor columnar crystal is flattened by pressurized thermal processing.

### TECHNICAL FIELD

The present invention relates to a scintillator panel which is employed during formation of radiation images of a subject and a method for manufacturing the same.

### BACKGROUND

Heretofore, radiation images such as X-ray images have widely been employed in hospitals and clinics for the state of a disease. Specifically, over a long period of history, radiation images formed via intensifying screen-film systems have resulted in high photographic speed and high image quality, whereby even now, they are employed in hospitals and clinics in the world as imaging systems which simultaneously exhibit high reliability and cost performance. However, types of the above image information are those of so-called analogue image information, and enable to achieve neither free image processing nor instantaneous electric transmission, which is realized in digital image information which has been developed in recent years.

Further, in recent years, digital system radiation image detection device, represented by computed radiography (CR) and flat-panel type radiation detectors (FPD) have appeared. These enable direct formation of digital radiation images and direct display images on image display devices such as a cathode tube or a liquid crystal panel can be achieved. When applying these radiographies, images are not always required to be formed on photographic film. As a result, the above digital system X-ray image detectors have decreased the need of image formation via silver halide photographic systems and have significantly enhanced convenience of diagnostic operation in hospitals and clinics.

As one of the digital technologies of X-ray images, computed radiography (CR) is presently employed in medical settings. However, sharpness is insufficient and spatial resolution is also insufficient, whereby its image quality level has not reached that of the screen-film systems. Further developed as a new digital X-ray image technology are flat-panel X-ray detectors (FPD) employing thin-film transistors (TFT), which are described, for example, on page 24 of John Rawland's report, “Amorphous Semiconductor Usher in Digital X-ray Imaging”, Physics Today, November 1997 and on page 2 of L. E. Antonku's report, “Development of a High Resolution, Active Matrix, Flat-panel Imager with Enhanced Fill Factor” of the magazine of SPIE, Volume 32, 1997.

In order to convert radiation to visible light, employed are scintillator panels which are prepared employing X-ray phosphors exhibiting characteristics of emitting light via radiation. However, in order to enhance the SN ratio during imaging at low dosages, it becomes necessary to employ scintillator panel at a high light emitting efficiency. Generally, the light emitting efficiency of scintillator panels is determined by the thickness of the phosphor layer (also called a “scintillator layer”) and the X-ray absorption coefficient, while as the thickness of the phosphor layer increases, scattering within the phosphor layer of emitted light occur, which lowers sharpness. Consequently, when required sharpness for image quality is determined, the layer thickness is determined.

Of the above phosphors, cesium iodide (CsI) exhibits a relatively high conversion ratio from X-rays to visible light and it is possible that phosphors are easily formed in a columnar crystal structure via vapor deposition. Consequently, scattering of emitted light in crystals is retarded via optical guide effects, whereby it has been possible to increase the thickness of the phosphor layer.

However, when only CsI is employed, the light emission efficiency is relatively low. Therefore, as described for example, in Japanese Patent Publication No. 54-35060, a mixture of CsI and sodium iodide (NaI) at any appropriate mol ratio is deposited on a substrate in the form of sodium-activated cesium iodide (CsI: Na), employing vapor deposition, and recently a mixture of CsI and thallium iodide (TlI) at any appropriate mol ratio is deposited on a substrate in the form of thallium-activated cesium iodide, employing vapor deposition. The resulting deposition is subjected to a thermal treatment at temperature of 200° C.-500° C. as a post-process to enhance the visible light conversion efficiency, whereby resulting materials are employed as an X-ray phosphor.

Further proposed as another means to increase light output are a method in which a substrate which forms a phosphor layer (scintillator layer) is made to be reflective (refer, for example, to Patent Document 1), a method in which a reflective layer is arranged on the substrate (refer, for example, to Patent Document 2), and a method in which a reflective thin-metal film arranged on the substrate and a phosphor layer on the transparent organic film covering the metal thin-film are formed (refer, for example, to Patent Document 3). These methods increase the resulting light amount, while problems occur in which the sharpness is significantly degraded.

Still further, methods to arrange a scintillator panel on the surface of a flat light receiving element are described, for example in JP-A No. 6-331749. However, these methods result in poor production efficiency, and degradation of sharpness on the scintillator panel and the flat light receiving element surface is unavoidable. Still further, method to arrange a scintillator panel by eliminating irregularities on the surface of a scintillator is described, for example in JP-A No. 2002-243859. However, this method results in poor light-emission efficiency, while irregularities on the surface of a scintillator can be reduced.

Heretofore, it has been common that as a production method of scintillators via a gas layer method, a phosphor layer is formed on a stiff substrate and the entire surface of the scintillator is covered with a protective film (refer, for example, to Patent Document 4). However, when the phosphor layer is formed on such a substrate, which is not easily bent, drawbacks result in which, during adhesion of the scintillator panel onto the surface of the flat light receiving element, uniform image quality characteristics are not realized in the light receiving plane of flat-panel detectors due to effects such as deformation of the substrate or curling during vapor deposition. Accordingly, in recent years such problems have risen along with the increase in size of flat-panel detectors.

In order to avoid such problems, commonly employed are a method in which a scintillator is formed directly onto the surface of an imaging element via vapor deposition, and a method in which a scintillator panel such as a flexible medical intensifying screen is employed as a substitute, while exhibiting low sharpness. Further, an example is disclosed in which a flexible protective layer such as poly(para-xylylene) is employed (refer, for example, to Patent Document 5).

However a uniform contact between a flat panel and a surface of a flat light receptive element cannot be obtained, because that aluminum or amorphous carbon utilized in the substrate is rigid and the deformation or the bending of the substrate occurs.

In order to avoid such the problem, a method has been proposed that a scintillator is formed on a flexible substrate such as polymer film by a vacuum evaporation method. However, the method has not been put into practical use since problem remains in low sharpness due to the columnar shape of the formed crystals, or difficulty of the post-treatment at high temperature.

On such the situation, development of a flat panel detector which is superior in the sharpness and low in the degradation of sharpness between the scintillator panel and the flat light receptive element surface is desired.

Patent Document 1 Examined Japanese Patent Publication (hereafter referred to as JP-B) No. 7-21560

Patent Document 2 JP-B 1-240887

Patent Document 3 Japanese Patent Publication Open to Public Inspection (hereafter referred to as JP-A.) No. 2000-356679

Patent Document 4 Japanese Registration Patent No. 3566926

Patent Document 5 JP-A 2002-116258

### SUMMARY OF THE INVENTION

### Problems to be Solved by the Invention

The present invention was intended in view of the above-described problems and an object thereof is to provide a scintillator panel which exhibits superior in the sharpness and graininess due to a uniform contact between a flat panel and a surface of a flat light receptive element; and further to provide a manufacturing method of the scintillator panel.

### Means to Solve the Problems

As a result of such diligent investigations in view of the foregoing, the inventors of the present invention discovered bellows:

at an optical coupling, an image having high graininess cannot be obtained when a flatness of the surface of phosphor layer on the scintillator panel is worse; an image having high sharpness cannot be obtained when a luminance of the phosphor layer on a side of a light receptive element is lower.

The above described object of this invention is attained as follow.

1. A scintillator panel comprising a polymer film substrate having thereon a phosphor layer comprising phosphor columnar crystal,

wherein a leading end portion of the phosphor columnar crystal is flattened by a pressurized thermal treatment.

2. The scintillator panel of item 1, wherein the polymer film substrate comprises a polymer film having thickness of 50 μm or more and 500 μm or less.
3. The scintillator panel of items 1 or 2, wherein the planarization by pressurized thermal treatment is carried out by a heat roller at temperature of 200° C. or more and 440° C. or less.
4. The scintillator panel of items 2 or 3, wherein the polymer film comprises polyimide or polyethylene naphthalate.
5. The scintillator panel of any one of items 1 to 4, wherein the phosphor layer is produced from a raw material comprising an additive having cesium iodide and thallium.
6. A method for manufacturing the scintillator panel of any one of items 1 to 4, wherein the leading end portion of the phosphor columnar crystal is flattened by pressurized thermal treatment by the heat roller at temperature of 200° C. or more and 440° C. or less.

### EFFECTS OF THE INVENTION

According to the present invention, the scintillator panel which exhibits superior in the sharpness and the graininess, small deterioration of image sharpness due to a uniform contact between the flat panel and the surface of the flat light receptive element; and the manufacturing method of the scintillator panel can be provided.

The effect of the invention arises from increasing sharpness due to increasing luminance at the leading edge portion of thermally pressured columnar crystal by flattening only the leading edge portion of the columnar crystal by the heat roller controlled at temperature of 200° C. or more and 440° C. or less without damaging the light guiding effect and further arises from increasing graininess due to a uniform contact between the flat panel and the surface of the flat light receptive element. The reason why the sharpness increases by increasing luminance at the leading edge portion of thermally pressured columnar crystal is coming from increasing the emitted light from the phosphor (scintillator) which located in near position from the flat light receptive element.

### BRIEF DESCRIPTION OF THE DRAWINGS

FIG. 1 is a schematic cross sectional view showing the constitution of the scintillator panel 10.

FIG. 2 shows an enlarged cross sectional view of the scintillator panel 10.

FIG. 3 is a schematic illustration showing the constitution of the vacuum evaporation apparatus 61.

FIG. 4 is a schematic partial cutaway perspective view of the constitution of the radiation image detection device 100.

FIG. 5 shows an enlarged cross sectional view of the imaging panel 51.

### DESCRIPTION OF THE ALPHANUMERIC DESIGNATIONS

1 Substrate
2 Phosphor layer (Scintillator layer)
3 Reflective layer
4 Sublayer
10 Scintillator panel
61 Vacuum evaporation apparatus
62 Vacuum chamber
63 Boat (member to be charged by vaporizing source material)
64 Holder
65 Rotation mechanism
66 Vacuum pump
100 Radiation image detection device

### DESCRIPTION OF THE PREFERRED EMBODIMENTS

The scintillator panel of the present invention, which incorporates a substrate having thereon a phosphor layer comprising phosphor columnar crystal, is characterized in that a leading end portion of the phosphor columnar crystal is flattened by a pressurized thermal treatment. This is common technical characteristic to the above-described claims 1-6.

“Flattened” as described herein, means that an irregularity of the phosphor is reduced by a pressurized thermal treatment described later, and the average roughness (Ra) of the surface of the phosphor based on JIS B 0601:2001 is 1.0 μm or less. The present invention and the components thereof will now be detailed.

(Constitution of Scintillator Panel)

The scintillator panel according to the present invention comprises a polymer film substrate having thereon a phosphor layer comprising phosphor columnar crystal, and preferably incorporates a sublayer between the substrate and the scintillator layer. Further, the scintillator panel incorporates a substrate having thereon a reflective layer, a sublayer and a scintillator layer in the stated order. The constitution of layers and the components thereof will now be described.

(Phosphor Layer: Scintillator Layer)

The phosphor layer (also referred to as “Scintillator layer”) of the present invention is characterized in a phosphor layer comprising phosphor columnar crystal, and further is characterized in that a leading end portion of the phosphor columnar crystal is flattened by a pressurized thermal treatment.

As the material for constituting the phosphor layer, various fluorescent materials may be used and cesium iodide (CsI) is preferable because cesium iodide has relatively high conversion ratio of from X-ray to visible light and the columnar crystal structure of the fluorescent material can be easily formed by the vapor deposition so that the scattering of the emitted light in the crystal can be avoided by the light guiding effect, whereby the thickness of the phosphor layer can be increased.

However, since CsI alone results in lower light emission efficiency, various activators are incorporated. One example is listed in which CsI and sodium iodide (NaI) are mixed at any appropriate mol ratio, as described in Japanese Patent Publication No. 54-35060. Further, as disclosed, for example, in JP-A No. 2001-59899, vapor-deposited CsI is preferred which incorporates activators such as thallium (Tl), europium (Eu), indium (In), lithium (Li), potassium (K), rubidium (Rb), or sodium (Na). In the present invention, particularly preferred are thallium (Tl) and europium (EU), but thallium (Tl) is more preferred.

In addition, in the present invention, it is preferable to employ, as raw materials, additives incorporating at least one type of thallium compounds and cesium iodide. Namely, thallium-activated cesium iodide (Cs:Tl) is preferred since it has a broad light emission wavelength of 400-750 nm.

Usable thallium compounds, as additives, which incorporate at least one thallium compound, according to the present invention, include various ones (namely compounds having an oxidation number of +I and −III).

In the present invention, preferred thallium compounds include thallium bromide (TlBr), thallium chloride (TlCl), and thallium fluorides (TlF and TlF₃).

Further, the melting point of the thallium compounds according to the present invention is preferably in the range of 400-700° C. When the melting point exceeds 700° C., additives in the columnar crystals are not uniformly oriented, resulting in a decrease in light emission efficiency. Meanwhile, the melting point in the present invention refers to one at normal temperature and pressure.

In the phosphor layer of the present invention, it is desirable that the content of the aforesaid additives is optimally regulated depending on the targeted performance. The above content is preferably 0.001-50 mol % with respect to the content of cesium iodide, but is more preferably 0.1-10.0 mol %.

When the added amount is less than 0.001 mol % with respect to cesium iodide, the resulting luminance of emitted light results in no significant difference from that obtained by employing cesium alone, whereby it is not possible to realize the targeted luminance of emitted light. On the other hand, when it exceeds 50 mol %, it is not possible to maintain properties and functions of cesium iodide.

In addition, in the present invention, after preparing the phosphor layer via vapor deposition of raw materials of the phosphor (scintillator) onto a polymer film, it is required to conduct a pressurized thermal treatment on the surface of the phosphor by a heat roller at the temperature of 200° C. or more and 440° C. or less and a leading end portion of the phosphor columnar crystal is flattened.

By this treatment, it is possible to provide a thermal treatment on a phosphor surface at the higher temperature than heatproof temperature of the polymer film used as substrate and it results in increasing luminance at the surface portion which can largely contribute to the sharpness. It is preferable to keep low temperature on the side of polymer film substrate so as to reduce damage to the polymer film side. Further the uniformity of the surface of the phosphor increases by this pressured treatment, and the graininess is also improved. Therefore the scintillator panel having the excellent sharpness and graininess can be realized.

### (Reflective Layer)

According to the present invention, the reflective layer is preferably employed on the polymer substrate so as to enhance light drawing efficiency by reflecting the light emitted from the phosphor (scintillator). It is preferable that the aforesaid reflective layer is formed employing materials incorporating any of the elements selected from the element group consisting of Al, Ag, Cr, Cu, Ni, Ti, Mg, Rh, Pt, and Au. Specifically, it is preferable to employ a thin metal film composed of the above metals, such as a Ag film, or an Al film. Further, at least two layers of the above may be formed.

### (Sublayer)

A sublayer according to the present invention is required to be arranged between the substrate and the phosphor layer, or between the reflective layer and the phosphor layer so as to improve the adhesion. Further, it is preferable that the aforesaid sublayer incorporates polymer binders (binders) and dispersing agents. In addition, the thickness of the sublayer is preferably 0.5-4 μm. When the thickness is 4 μm or more, light scattering in the sublayer increases to result in deterioration of sharpness. Further, when the thickness of the sublayer is 5 μm or more, the columnar crystal structure is disordered by thermal treatment. The components of the sublayer will now be described.

### <Polymer Binders>

It is preferable that the sublayer according to the present invention is formed by coating polymer binders (hereinafter also referred to as “binders”) which are dissolved or dispersed in solvents, followed by drying. It is preferable to specifically employ, as polymer binders, polyurethane, vinyl chloride copolymers, vinyl chloride-vinyl acetate copolymers, vinyl chloride-vinylidene chloride copolymers, vinyl chloride-acrylonitrile copolymers, butadiene-acrylonitrile copolymers, polyamide resins, polyvinyl butyral, polyester, cellulose derivatives (such as nitrocellulose), styrene-butadiene copolymers, various synthetic rubber based resins, phenol resins, epoxy resins, urea resins, melamine resins, phenoxy resins, silicone resins, acryl based resins, and urea formamide resins. Of these, it is preferable to employ polyurethane, polyester, vinyl chloride based copolymers, polyvinyl butyral, and nitrocellulose.

In view of close contact with the phosphor layer, specifically preferred as the polymer binders according to the present invention are polyurethane, polyester, vinyl chloride copolymers, polyvinyl butyral, and nitrocellulose. Further, in view of the adhesion between the vapor deposition crystals and the substrate, preferred are polymers which exhibit a glass transition temperature (Tg) of 30-100° C. In the above point of view, specifically preferred as the polymer binders are polyester resins.

As the solvent to be used for forming the protective layer, a lower alcohol such as methanol, ethanol, n-propanol and n-butanol; a chlorine atom-containing hydrocarbon such as methylene chloride and ethylene chloride; a ketone such as acetone, methyl ethyl ketone and methyl isobutyl ketone; an aromatic compound such as toluene, benzene, cyclohexane, cyclohexanone and xylene; an ester of lower fatty acid and lower alcohol such as methyl acetate, ethyl acetate and butyl acetate; an ether such as dioxane, ethylene glycol monoethyl ester and ethylene glycol monomethyl ester and a mixture of them are usable.

In order to minimize scattered light emitted by phosphors (scintillators) and to enhance sharpness, pigments and dyes may be incorporated into the sublayer according to the present invention.

### (Protective Layer)

The protective layer according to the present invention is mainly aimed to protect the phosphor layer. Namely, cesium iodide (CBI) easily absorbs moisture. When it is exposed to an ambient atmosphere, it is subjected to deliquescence via absorption of moisture from the atmosphere. Consequently, the protective layer is provided to minimize the above deliquescence.

It is possible to form the aforesaid protective layer employing various materials. For example, as the protective layer, polyparaxylylene layer can be formed by CVD method on all surfaces of phosphor and substrate.

As other type of protective layer, a polymer film can be formed on the phosphor layer. As for the polymer film, a same polymer film as the material for the substrate described later can be used.

In consideration of void formation, protection of the phosphor layer, sharpness, moisture resistance, and workability, the thickness of the above protective film is preferably 12-120 μm, but is more preferably 20-80 μm. Further, in consideration of sharpness, irregularity of radiographic images, production stability, and workability, the haze ratio is preferably 3-40%, but is more preferably 3-10%. “Haze ratio” refers to the value determined by NIGH 5000 W of Nippon Denshoku Industries Co., Ltd. Films at a desired haze ratio are readily available on market via suitable selection.

In the present invention, upon considering a photoelectric conversion ratio and the wavelengths of radiation emitted by phosphors (scintillators), the light transmission of the first protective film is preferably at least 70% at 550 nm. However, since it is industrially difficult to produce a film of a light transmission of at least 99%, in practice, the light transmission is preferably 99-70%.

In regard to protection of the phosphor layer and deliquescence, the moisture vapor transmittance of the protective film is preferably at most 50 g/m²·day (at 40° C. and 90% relative humidity) (determined based on JIS Z 0208), but is more preferably 10 g/m²·day (at 40° C. and 90% relative humidity) (determined based on JIS Z 0208). However, since it is industrially difficult to produce a high light transmission film of at most 0.01 g/m²·day (at 40° C. and 90% relative humidity), in practice, the moisture vapor transmittance is preferably 0.01-50 g/m²·day (at 40° C. and 90% relative humidity) (determined based on JIS Z 0208), but is more preferably 0.1-10 g/m²·day (at 40° C. and 90% relative humidity) (determined based on JIS Z 0208).

The scintillator panel of the present invention is characterized by using the polymer film as the substrate. Polymer film (plastic film) such as cellulose acetate film, polyester film, polyethylene terenaphthalate (PEN) film, polyamide film, polyimide (PI) film, triacetate film, polycarbonate film, carbon fiber reinforced resin sheet can be used. Specifically polymer film containing polyimede or polyethylene terenaphthalate is preferred when phosphor columnar crystal is formed from cesium iodide as raw material by using gas phase method.

Polymer film as a substrate according to the present invention preferably has a thickness of 50 through 500 μm and further preferably has flexibility.

“Flexible substrate” means the substrate having an elastic modulus at 120° C. (E120) of 1000-6000 N/mm². Polymer film containing polyimide or polyethylene naphthalate is preferably used as this substrate.

“Elastic modulus” is calculated from the slope of stress against strain in the rage which a stress has linear relation with a strain indicated by a marked line on a sample complying with JIS-C2318 by using tensile tester.

The substrate of the present invention preferably has an elastic modulus at 120° C. (E120) of 1000-6000 N/mm², more preferably 1200 N/mm²-5000 N/mm².

Specific example of polymer film include polyethylene naphthalate (E120=4100 N/mm²), polyethylene terephthalate (E120=1500 N/mm²), polybutylene naphthalate (E120=1600 N/mm²), polycarbonate (E120=1700 N/mm²), syndiotactic polystyrene (E120=2200 N/mm²), polyetherimide (E120=1900 N/mm²), polyarylate (E120=1700 N/mm²), polysulphone (E120=1800 N/mm²), and polyethersulphone (E120=1700 N/mm²).

These are utilized alone or in laminated or mixed state. As described above, polymer film containing polyimide or polyethylene naphthalate is preferably used.

Occasionally, during arrangement of the scintillator panel facing the surface of a flat light receiving element, uniform image quality characteristics are not obtained due to effects such as the deformation of the substrate and curling during vapor deposition. In order to overcome the above drawbacks, a polymer film substrate of a thickness of 50-500 μm is employed as the aforesaid substrate so that the scintillator panel is deformed to the shape matching that of the surface of the flat light receiving element, whereby uniform sharpness is realized over the entire light receiving surface of the flat-panel detector.

(Preparation Method of Scintillator Panel)

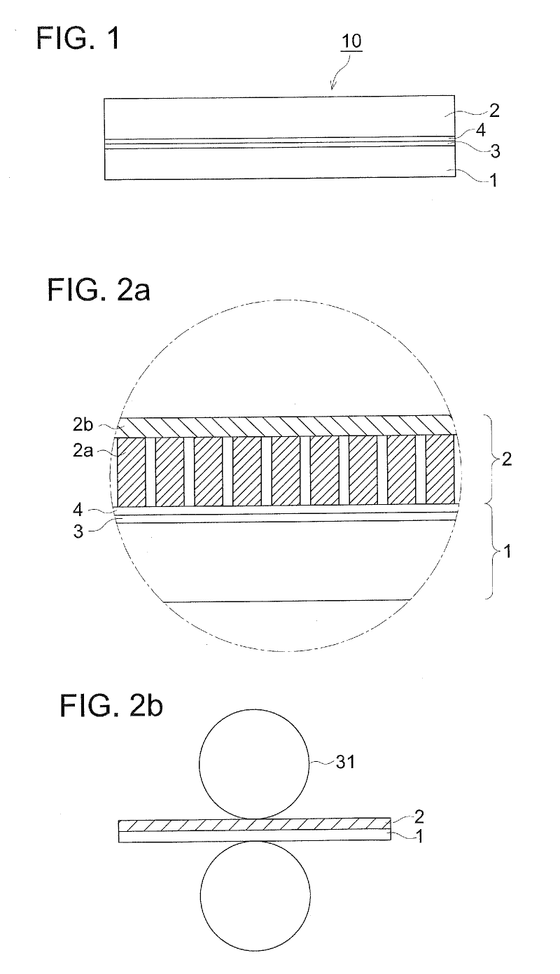

Typical example of preparation method of the scintillator panel of the present invention is described below referring the drawing. FIG. 1 is a cross section showing the outline of the constitution of the scintillator panel 10. FIG. 2A displays an enlarged cross section of the scintillator panel 10. A reflective layer 3, a sublayer 4 and a scintillator layer 2 are incorporated on a substrate 1 in the stated order. A leading end portion 2b of the phosphor layer 2 is flattened by a pressurized thermal treatment of the present invention.

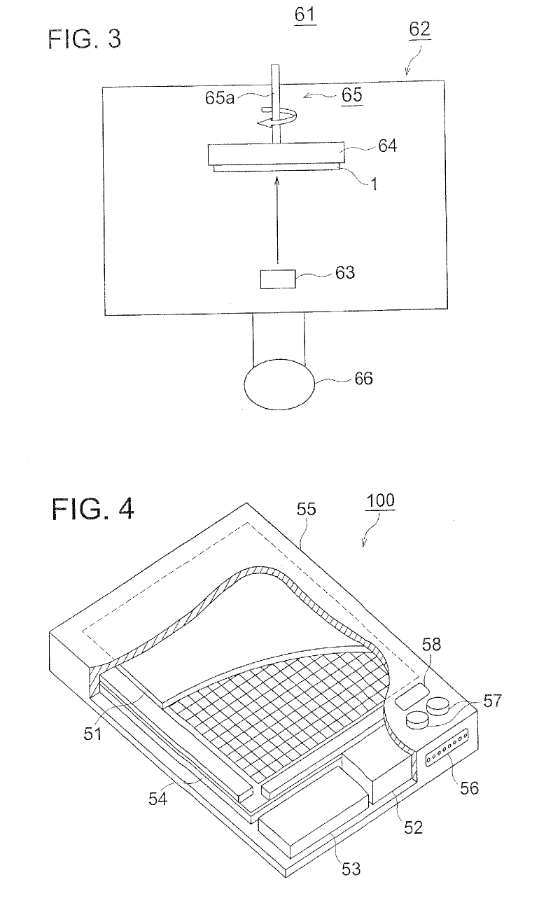

FIG. 2B is a drawing of pressurized thermal treatment. 31 show the heat roller having temperature of 200-440° C. FIG. 3 is a drawing displaying the outline of the constitution of a vacuum evaporation apparatus 61.

(Vacuum Evaporation Apparatus)

As is shown in FIG. 3, the vacuum evaporation apparatus 61 has a box type vacuum chamber 62 in which a boat for vacuum evaporation 63 is placed. The boat 63 is a member in which the vaporizing source material is charged and an electrode is connected to the boat 63. The boat is heated by Joule heat when electric current is applied through the electrode. On the occasion of producing the scintillator panel 10, a mixture containing cesium iodide and the activator compound is charged into the boat 63 and the mixture can be heated and vaporized by applying electric current to the boat 63.

An alumina crucible wound by a heater or a boat made of a metal with high melting point may be applied as the member to be charged by the raw materials.

In the vacuum chamber 62, a holder 64 for holding the substrate 1 is arranged just above the boat 63. A heater, not shown in the drawing, is attached to the holder and the substrate 1 held by the holder 64 can be heated by turning on the heater. Substances adsorbed on the surface of the substrate can be released or removed so that the formation of impurity layer between the substrate 1 and the phosphor layer (scintillator layer) 2 formed on the substrate surface can be prevented, the adhesion between the substrate 1 and the phosphor layer 2 formed on the substrate surface can be strengthen and the properties of the phosphor layer formed on the surface of the substrate 1 can be controlled by heating the substrate 1.

A rotation mechanism 65 for rotating the substrate holder 64 is attached to the holder 64. The rotation mechanism is constituted by a rotation axis 65a connected with the holder 64 and a motor, not shown in the drawing, for driving the rotation axis, and the holder 64 is rotated while facing to the boat 63 by driving the motor to rotate the rotation axis 65a.

In the vacuum evaporation apparatus 61, a vacuum pump 66 is provided to the vacuum chamber 62 additionally to the above-mentioned. The vacuum pump 66 evacuates air in the vacuum chamber 62 and introduces gas into the vacuum chamber 62, and the gas atmosphere in the vacuum chamber 62 can be maintained at constant pressure by the action of the vacuum pump 66.

<Scintillator Panel>

The preparation method of the scintillator panel 10 of the present invention is described below.

The above described vacuum evaporation apparatus 61 can be suitably applied in the manufacturing method of the scintillator panel 10. The method for manufacturing the scintillator panel 10 using the vacuum evaporation apparatus 61 will be described below.

<<Formation of Reflection Layer>>

A thin layer of metal such as aluminum and silver as the reflection layer is formed by sputtering on one surface of the substrate 1. Various kinds of polymer film on which aluminum layer is sputtered are distributed on the market, and such the films can be used as the substrate relating to the present invention.

<<Formation of Sublayer>>

The sublayer is formed by coating and drying a composition prepared by dissolving a polymer binder into the foregoing organic solvent. As the polymer binder, a hydrophobic resin such as polyester rein and polyurethane resin is preferable from the viewpoint of adhesive property and anti-erosion ability of the reflection layer.

<<Formation of Phosphor Layer>>

The substrate 1 on which the reflection layer and the sublayer are provided as above is attached on the holder 64 and a powder mixture containing cesium iodide and thallium iodide is charged in the boat 63 (preliminary process). It is preferable to set the distance between the boat 63 and the substrate 1 at a value within the range of from 100 to 1,500 mm and to carry out the later-mentioned vacuum evaporation while keeping the distance within the above range.

After the above preliminary process, air in the vacuum chamber 62 is exhausted by vacuum pump 66 to make a vacuum atmosphere of not more than 0.1 Pa in the vacuum chamber 62 (vacuum atmosphere formation process). Here, the “vacuum atmosphere” means an atmosphere with a pressure of not more than 100 Pa and the pressure is suitably not more than 0.1 Pa.

After that, inert gas such as argon is introduced into the vacuum chamber 62 and the interior of the vacuum chamber is maintained at the vacuum atmosphere of not more than 0.1 Pa. Then the heater of the holder 64 and the motor of the rotation mechanism are driven so as to rotate the substrate 1 attached on the holder 64 while heating and facing to the boat 63.

In such the situation, the mixture containing cesium iodide and thallium iodide is heated at a temperature about 700° C. for designated time to evaporate the mixture by applying electric current to boat 63 through the electrode. As a result of that, innumerable columnar crystals 2a are gradually grown on the surface of the substrate 1 and a phosphor layer having desired thickness is formed (vacuum evaporation process). After that, the phosphor layer 2 can be produced by pressurized treatment by using the heat roller at a temperature of 200° C.-440° C. The scintillator panel 10 relating to the present invention can be produced by above method.

In the above-mentioned, various improvement and design variation may be applied within the range of not deviate the purport of the present invention.

As for one of the design variation, techniques for thermal treatment include electron beam heating and high-frequency induction heating as well as electrical resistance heating described in the above evaporation step, but resistance heating is preferred in terms of relatively simple constitution, low price and applicability to various materials. By applying heating by electrical resistance heating, both heat and evaporation treatment of the mixture of cesium iodide and thallium iodide can be carried out by using the same boat 63.

As for other design variation, there may be provided a shutter (not designated in this drawing) between boat 63 of the evaporating apparatus 51 and boat 63 to cutoff the space from the boat 63 to the holder 64. Non-objective materials adhered onto the surface of a mixture on the boat 63 are evaporated through the shutter at the initial stage of evaporation, preventing deposition onto the substrate 1.

(Radiation Image Detection Device)

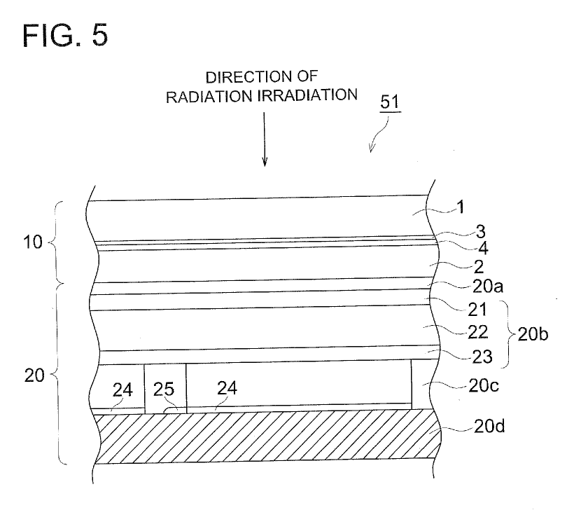

The constitution of a radiation image detection device 100 having the scintillator panel 10 is described below referring FIGS. 4 and 5 as an application example of the scintillator panel 10. FIG. 4 is a partially broken oblique view showing the out line of the constitution of the radiation image detection device 100. FIG. 5 is an enlarged cross section of imaging panel 51.

As is shown in FIG. 4, the radiation image detection device 100 has a case 55 in which the imaging panel 51, a controlling means 52 for controlling the movement of the radiation image detection device 100, a memory means 53 as a means for memorizing image signals generation from the imaging panel 51 using a rewritable exclusive memory such as a flash memory and a power source 54 as an electric power supplying means for supplying electric power necessary for driving the imaging panel 51 to obtain the image signals are provided.

On the case 55, a connector 56 for informing between the radiation image detection device 100 and the exterior, an operation means 57 for changing the action of the radiation image detection device 100 and a displaying means 58 for displaying the completion of imaging preparation and that of writing of designated amount of the image signals into the memory 53 are provided according to necessity.

The radiation image detection device 100 can be made portable by providing the power supplying means 54 and the memory 53 for memorizing the image signals of the radiation image to the radiation image detection device 100 and making the radiation image detection device 100 to be able to freely connecting and releasing through the connector 56.

As is shown in FIG. 5, the imaging panel 51 is constituted by the scintillator panel 10 and an output base board 20 for absorbing the magnetic wave from the scintillator panel 10 and generating the image signals.

The scintillator panel 10 is placed on the radiation incidental side and generates electromagnetic waves corresponding to the intensity of the incident radiation.

The output base board 20 is provided on the side opposite to the radiation incident face of the scintillator panel 10 and has a separation layer 20a, a photoelectric conversion element 20b, an image signal generation layer 20c and a basic board 20d in the order of from the scintillator panel side.

The separation layer 20a is a layer for separating the scintillator panel 10 from the other layers.

The photoelectric conversion element 20b is constituted by a transparent electrode 21, a charge generation layer 22 for generating charge when excited by electromagnetic waves permeated through the transparent electrode, and a counter electrode 23 for being the counter electrode to the transparent electrode 21, which are arranged in the order of the transparent electrode, the charge generation layer 22 and the counter electrode 23 from the side of the separation layer 20a.

The transparent electrode 21 is an electrode let passing electromagnetic waves to be subjected to photoelectric conversion, and is formed by an electroconductive transparent material such as indium, tin oxide (ITO), SnO₂ and ZnO, for example.

The charge generation layer 22 is formed as a thin layer on one side of the transparent electrode 21, which contains an organic compound capable of conversing light to electric current by separating electric charge by light, and an electron donor capable of generating charge and an electroconductive compound as an electron acceptor. In the charge generation layer 22, the electron donor is exited and releases electrons when irradiated by the electromagnetic waves and the released electrons are transferred to the electron acceptor so that charge namely carriers of positive hole and electron are generated.

As the electroconductive compound for the electron donor, p-type electroconductive polymer compounds can be cited. As the p-type electroconductive polymer, ones having a basic skeleton of polyphenylenevinylene, polythiophene, poly(thiophene-vinylene), polyacetylene, polypyrrole, poly(p-penylene) or polyaniline.

As the electroconductive compound for the electron acceptor, n-type electroconductive compounds can be cited. As the n-type electroconductive compound, ones having a basic skeleton of pyridine are preferable and ones having a basic skeleton of poly(p-pyridylvinylene) are particularly preferred.

The thickness of the charge generation layer 22 is preferably not less than 10 nm and particularly preferably not less than 100 nm for maintaining the light absorbing amount and preferably not more than 1 μm and particularly preferably not more than 300 nm from the viewpoint of that the electric resistivity does not become too high.

The counter electrode 23 is provided on the side of the charge generation layer opposite to the side to which the light is irradiated. The material of the counter 23 can be selected from a usual metal such as gold, silver, aluminum and chromium, and the materials used for the transparent electrode 21, and a metal, alloy electroconductive compound and a mixture of them having a low work function of not more than 4.5 eV is preferable for obtaining suitable property.

A buffer layer may be provided between the charge generation 22 and each of the electrodes the transparent electrode 21 and the counter electrode 23) arranged on both sides of the charge generation layer 22. The buffer layer functions as a buffer zone for preventing reaction between the charge generation layer with the transparent electrode or the counter electrode. The buffer layer is formed by lithium fluoride and poly(3,4-ethylenedioxythiophene), poly(4-stylenesulfonate) or 2,9-dimethyl-4,7-diphenyl[1,10]-phenanthroline for example.

The image signal generation layer 20c accumulates the charge obtained by the photoelectric conversion 20b and generates signals according to the accumulates charge, which is constituted by a condenser 24 as the charge accumulation element for accumulating the charge of each pixels obtained by the photoelectric conversion element and a transistor 25 as an image signal generation element.

As the transistor 25, for example, a thin film transistor (TFT) is used. The TFT may be an inorganic type transistor usually used for liquid crystal displays or that using an organic semiconductor, and preferably a TFT formed on plastic film. As the TFT formed on the plastic film, ones of amorphous silicon type are known, and a TFT formed on a flexible plastic film by arranging micro CMOS (Nanoblocks) formed by silicon single crystal on an embossed plastic film which is manufactured by Fluidic Self Assembly (FSA) technology developed by Alien Technology Corp. may be applied. TFTs using organic semiconductor such as those described in Science, 283, 822 (1999), Phys. Lett. 771488 (1998) and Nature, 403, 521 (2000) may be also used.

As the transistor 25 to be used in the present invention, the TFT manufactured by the FSA technology and that using the organic semiconductor are preferable and the TFT using the organic semiconductor is particularly preferred. When the TFT is constituted by the organic semiconductor, any vacuum evaporation equipment to be used for manufacturing the TFT using silicon is not necessary and the TFT can be formed by applying printing technology and ink-jet technology. Therefore, the production cost can be lowered and the transistor can be formed on a plastic substrate having low resistivity against heat since processing temperature can be lowered.

A collector electrode, not shown in the drawing, is connected to the transistor 25, which accumulates the charge generated by the photoelectric conversion element 20b and functions as one electrode of the condenser 24. The charge generated by the photoelectric conversion element 20b is accumulated by the condenser and the accumulated charge is readout by driving the transistor 25. Namely, the signal of each of the pixels of the radiation image can be output by driving the transistor 25.

The base board 20d functions as the support of the imaging panel 51 and can be constituted by a material the same as that of the substrate 1.

The function of the radiation image detection device 100 is described below.

Incident radiation to the radiation image detection device 100 permeates in the direction of from the side of the scintillator panel 10 of the imaging panel 51 to the base board 20d.

The phosphor layer 2 in the scintillator panel 10 absorbs energy of the radiation and generates electromagnetic waves corresponding to the intensity of the radiation. Among the generated electromagnetic waves, the electromagnetic waves irradiated to the output base board 20 arrives to the charge generation layer 22 through the separation layer 20a and the transparent electrode 21 of the output board 20. The electromagnetic waves are absorbed by the charge generation layer 22 and pairs of positive hole and electron (charge separation state) are formed corresponding to the intensity of the electromagnetic waves.

After that, the generated positive holes and electrons are each transferred to different electrodes (the transparent electrode layer and electroconductive layer) by the interior electric field formed by bias voltage applied from the power source 54. As a result of that photocurrent is generated.

Then the positive holes transferred to the counter electrode are accumulated in the condenser 24 of the image signal generation layer 20c. The positive holes accumulated in the condenser 24 generates image signals when the transistor 25 connected to the condenser 24 is driven and the generated image signals are memorized by the memory means 53.

The photoelectric conversion efficiency can be raised, the S/N ratio of the radiation image taken by low dosage aging can be improved and occurrence of unevenness of the image and line-shaped noises can be prevented by the radiation image detection device 100 since which has the above-mentioned scintillator panel 10.

### EXAMPLES

### Preparation of Substrate 1 Having Reflection Layer

Aluminum was sputtered on polyimide films having thickness of 125 μm and width of 500 mm to form a reflection layer (0.10 μm).

(Preparation of Sublayer)

| | |
|---|---|
| Vylon 20SS (high molecular weight polyester | 300 parts by weight |
| resin manufactured by Toyobo Co., Ltd.) | |
| Methylethyl ketone (MEK) | 200 parts by weight |
| Toluene | 300 parts by weight |
| Cyclohexanone | 150 parts by weight |

The above composition was mixed and dispersed by a beads mill 15 hours to prepare a coating liquid for subbing coating. The coating liquid was coated by a spin coater on the reflective layer side of the above substrates so as to be make the dry layer thickness to 1.0 μm and dried at 100° C. for 8 hours to form a sublayer.

(Formation of Phosphor Layer)

Fluorescent material (CsI: 0.03Tl mol %) was deposited on the sublayer side of the substrate to form a phosphor layer by the vacuum evaporation apparatus shown in FIG. 3.

Namely, the above fluorescent raw materials were charged in the resistor heating boat and the substrate was attached on the rotatable substrate holder, and the distance between the substrate and the vaporizing source was adjusted to 400 mm.

After that, the air in the vacuum evaporation apparatus was once evacuated and Ar gas was introduced to adjust the vacuum degree to 0.5 Pa, then the temperature of the substrate was held at 200° C. while rotating the substrate at a rate of 10 rpm. Then the fluorescent material was vapor deposited by heating the resistor heating boat and the deposition was completed when the thickness of the phosphor layer came up to 500 μm to obtain a the phosphor layer.

(Pressurized Thermal Treatment)

The substrate having the phosphor layer thereon with 500 mm width was pressured thermal treated by a calendar apparatus under the condition of total pressure 200 kg at rate of 0.1 m/min, while the temperature was set up at the temperature shown in Table 1 for the roller faced to the phosphor layer side and at 40° C. for the roller faced to the substrate side. Then the substrate was cut down to the size of 10 cm×10 cm. As for the comparative example, sample without pressured thermal treatment was also cut down to the size of 10 cm×10 cm.

(Evaluation)

Each of the prepared samples was set on the CMOS flat panel (X-ray CMOS camera system Shad-o-Box 4KEV manufactured by Rad-icon Imaging Corp.) and the luminance and the image sharpness of the 12 bit output data was measured by the following method. The results of evaluation measured by the following method are shown in Table 1.

The flat light receptive element and the scintillator panel were fixed by placing sponge sheets on the carbon plate of the radiation incident window and the radiation incident side of the scintillator panel (the radiation incident side having no phosphor layer) and lightly pressing the flat light receptive element onto the scintillator panel.

<Evaluation Method of Luminance>

The backside (the face on which the phosphor layer is not formed) of each sample was irradiated with an X-ray of tube voltage of 80 kVp and the image data were detected by a CMOS flat panel and the luminance of the emission was determined by the average signal value of the image. The results of evaluation are shown in Table 1 below. In Table 1, the values of luminance of each sample are the relative value based on the luminance of the emission of the comparative sample being 1.0.

<Evaluation Method of Sharpness>

The backside (the face on which the phosphor layer is not formed) of each sample was irradiated with an X-ray of tube voltage of 80 kVp through a lead MTF chart and the image data were detected by a CMOS flat panel and recorded on a hard disc. And then the records on the hard disc were analyzed and the modulation transfer function (MFT) at a spatial frequency of 1 cycle/mm of the X-ray image recorded on the hard disc was determined as the indicator of the image sharpness. In the table, higher MFT value corresponds to superiority in the sharpness namely superior in the columnar property and high in the light guiding ability. MFT is an abbreviation of Modulation transfer Function.

The results of evaluation are shown in Table 1.

TABLE 1

| | Temperature | Relative | MTF |
|---|---|---|---|
| Example | of Roller (° C.) | Luminance | (1 cycle/mm) |
| Comparative | — | 1.00 | 0.48 |
| Example 1 | 100 | 1.10 | 0.50 |
| Example 2 | 150 | 1.13 | 0.51 |
| Example 3 | 200 | 1.20 | 0.60 |
| Example 4 | 300 | 1.41 | 0.62 |
| Example 5 | 400 | 1.41 | 0.60 |
| Example 6 | 450 | 1.41 | 0.53 |

As can clearly be seen from the results shown in Table 1, the examples according to the present invention are excellent in the luminance and the sharpness compared to the comparative example. Therefore, according to the present invention, the scintillator panel which exhibits superior in the sharpness and the graininess, small deterioration of image sharpness due to a uniform contact between the flat panel and the surface of the flat light receptive element; and the manufacturing method of the scintillator panel can be provided.

1. A scintillator panel comprising a polymer film substrate having thereon a phosphor layer comprising phosphor columnar crystal,
wherein a leading end portion of the phosphor columnar crystal is flattened by a pressurized heat treatment.

2. The scintillator panel of claim 1, wherein the polymer film substrate comprises a polymer film having thickness of 50 μm or more and 500 μm or less.

3. The scintillator panel of claim 1, wherein the planarization by pressurized heat treatment is carried out by a heat roller at temperature of 200° C. or more and 440° C. or less.

4. The scintillator panel of claim 2, wherein the polymer film comprises polyimide or polyethylene naphthalate.

5. The scintillator panel of claim 1, wherein the phosphor layer is produced from a raw material comprising an additive having cesium iodide and thallium.

6. A method for manufacturing the scintillator panel of claim 1, wherein the leading end portion of the phosphor columnar crystal is flattened by pressurized heat treatment by the heat roller at temperature of 200° C. or more and 440° C. or less.
